(19) United States
(12) Patent Application Publication
(10) Pub. No.: US 2026/0118144 A1
(43) Pub. Date: Apr. 30, 2026

(54) ACTUATOR-BASED TESTING SYSTEMS DATA COMMUNICATION

(71) Applicant: Illinois Tool Works Inc., Glenview, IL (US)

(72) Inventors: James Foster Knutson, Minnetonka, MN (US); Norman L. Oberski, Chaska, MN (US); Steven Kvidera, Chanhassen, MN (US); Erik Schwarzkopf, Minneapolis, MN (US); Timothy Joel Wolf, Eden Prairie, MN (US); Jon A. Wilson, Hopkins, MN (US); Sridhar P. Iyer, Plymouth, MN (US)

(21) Appl. No.: 19/369,947

(22) Filed: Oct. 27, 2025

Related U.S. Application Data
(60) Provisional application No. 63/714,637, filed on Oct. 31, 2024.

(51) Int. Cl. G01D 18/00; G01D 21/02; G06F 3/0484

(52) U.S. Cl. CPC G01D 18/00; G01D 21/02; G06F 3/0484; G01D 2218/10

(57) ABSTRACT

A non-transitory computer-readable medium having stored thereon a test program having instructions which, when executed by a processor of a testing system controller of a testing system, configures the testing system controller to perform a test operation, in which a controllable element of a test machine is controlled to apply a load and/or a displacement to a specimen based on a controllable element activity of the test program, and sensor data is written to a designated computer-readable medium based on one or more sensor data writing activities of the test program. The sensor data corresponds to a test sensor of the test machine that is configured to measure a response from the specimen or provide feedback for controlling the controllable element. The sensor data includes sensor calibration data corresponding to one or more calibration parameters of the test sensor and/or sensor information data including non-sensed information about the test sensor.

### CROSS-REFERENCE TO RELATED APPLICATION(S)

The present application is based on and claims the benefit of U.S. provisional patent application Ser. No. 63/714,637, filed Oct. 31, 2024, the content of which is hereby incorporated by reference in its entirety.

### FIELD

Embodiments of the present disclosure generally relate to actuator-based testing systems and, more particularly, to test programs that control actuator-based testing systems to perform a test operation.

### BACKGROUND

Actuator-based testing systems, such as those developed by MTS Systems Corporation, may be used to test materials and devices. For example, such testing systems may provide vehicle testing through the application of simulated driving conditions to a mobile vehicle or vehicle component, building testing through the application of simulated seismic activity to a building, and other device and materials testing. The testing systems perform such testing using test machines that include one or more controllable elements (e.g., actuators) that apply a displacement or a load to a test specimen, and test sensors that measure aspects of a response from the test specimen and/or to provide feedback for controlling the test.

The test operations are controlled based on a test program, which a user may create through a graphical user interface (GUI) of a program generator. The test program generally includes a test flow that defines various process steps that are to be performed during the test operation. The test flow can be complicated, with conditional branching, parallel procedures, loop back, and many more different configurations of the process flow.

The process steps defined by the test flow may include, for example, controlling a controllable element to apply a load and/or a displacement to a specimen, acquiring test data from one or more of the test sensors (e.g., a displacement, force, etc.), performing a calculation based on the acquired test data (e.g., calculate strain), and other process steps. The process steps may also involve the writing of certain types of data during the test operation to a computer-readable medium, such as sensor data and calculated data, for example.

### SUMMARY

Embodiments of the present disclosure relate to test programs that control actuator-based testing systems to perform a test operation including a non-transitory computer-readable medium storing a test program, a computer-implemented method for generating a test program for a testing system, and a testing system that uses a test program to perform a test operation.

In one embodiment of the non-transitory computer-readable medium having stored thereon a test program, the test program includes instructions which, when executed by a processor of a testing system controller of a testing system, configures the testing system controller to perform a test operation, in which a controllable element of a test machine is controlled to apply a load and/or a displacement to a specimen based on a controllable element activity of the test program, and sensor data is written to a designated computer-readable medium based on one or more sensor data writing activities of the test program. The sensor data corresponds to a test sensor of the test machine that is configured to measure a response from the specimen to the applied load and/or displacement or provide feedback for controlling the controllable element. The sensor data includes sensor calibration data corresponding to one or more calibration parameters of the test sensor and/or sensor information data comprising non-sensed information about the test sensor.

In one embodiment, the controllable element is selected from the group consisting of a hydraulic actuator, a pneumatic actuator and an electric actuator, and the test sensor is selected from the group consisting of a load cell, a torque transducer, a pressure transducer, a displacement sensor, an extensometer and an accelerometer.

In one embodiment, the one or more sensor data writing activities each define the designated computer-readable medium and a format in which the sensor data is written during execution of the sensor data writing activity.

In one embodiment, the format is selected from the group consisting of extensible markup language, comma-separated values and tab-delimited values.

In one embodiment, the sensor data includes the sensor calibration data, which includes: an excitation value corresponding to a voltage of an excitation signal used to drive the test sensor to sense a condition; a scale for the test sensor defining minimum and maximum values for the output from the test sensor; a gain for the output signal generated by the test sensor; a demodulation phase of the output signal generated by the test sensor; a polarity of the output signal generated by the test sensor; a calibration method type used to calibrate the test sensor; a zero of the output signal generated by the test sensor; linearization data defining a transformation or conditioning used to translate sensed values output by the test sensor to expected values; a tuning parameter of the test sensor corresponding to adjustable properties of the control loop type; and/or a tuning parameter name corresponding to the tuning parameter of the test sensor.

In one embodiment, the sensor data includes the sensor information data, which includes: a sensor conditioner serial number identifying the sensor conditioner; a dimension corresponding to a value represented by the output signal generated by the test sensor; a hardware resource identifier of a hardware resource of the sensor conditioner; a calibration date identifying when the test sensor was last calibrated; a manufacturer name identifying a manufacturer of the test sensor; a model identifying a model of the test sensor; a sensor name identifying the test sensor; and/or a serial number of the test sensor.

In one embodiment of the computer-implemented method for generating a test program for a testing system, a graphical user interface (GUI) configured to receive user input is provided and a plurality of activities are displayed in the GUI. The activities including one or more controllable element activities, each defining an application of a load and/or a displacement to a specimen using a controllable element of a test machine during execution of the test program, and one or more sensor data writing activities, each defining a write operation of sensor data during execution of the test program. The sensor data corresponds to a test sensor of the test machine that is configured to measure a response from the specimen to the applied load and/or displacement or provide feedback for controlling the controllable element. The sensor data includes sensor calibration data corresponding to one or more calibration parameters of the test sensor, and/or sensor information data comprising non-sensed information about the test sensor. A test workflow is created by adding one or more of the controllable element activities to a test workflow window based on user input to the GUI, and adding one or more of the data writing activities to the test workflow window based on user input to the GUI. The test program is generated based on the test workflow and saved in a non-transitory computer readable medium.

In one embodiment, the controllable element is selected from the group consisting of a hydraulic actuator, a pneumatic actuator and an electric actuator, and the test sensor is selected from the group consisting of a load cell, a torque transducer, a pressure transducer, a displacement sensor, an extensometer and an accelerometer.

In one embodiment, the one or more sensor data writing activities each define the designated computer-readable medium and a format in which the sensor data is written during execution of the sensor data writing activity.

In one embodiment, the format is selected from the group consisting of extensible markup language, comma-separated values and tab-delimited values.

In one embodiment, the sensor data includes the sensor calibration data, which includes: an excitation value corresponding to a voltage of an excitation signal used to drive the test sensor to sense a condition; a scale for the test sensor defining minimum and maximum values for the output from the test sensor; a gain for the output signal generated by the test sensor; a demodulation phase of the output signal generated by the test sensor; a polarity of the output signal generated by the test sensor; a calibration method type used to calibrate the test sensor; a zero of the output signal generated by the test sensor; linearization data defining a transformation or conditioning used to translate sensed values output by the test sensor to expected values; a tuning parameter of the test sensor corresponding to adjustable properties of the control loop type; and/or a tuning parameter name corresponding to the tuning parameter of the test sensor.

In one embodiment, wherein the sensor data includes the sensor information data, which includes: a sensor conditioner serial number identifying the sensor conditioner; a dimension corresponding to a value represented by the output signal generated by the test sensor; a hardware resource identifier of a hardware resource of the sensor conditioner; a calibration date identifying when the test sensor was last calibrated; a manufacturer name identifying a manufacturer of the test sensor; a model identifying a model of the test sensor; a sensor name identifying the test sensor; and/or a serial number of the test sensor.

One embodiment of the testing system includes a test machine and a test system controller. The test machine includes a controllable element configured to apply a load and/or a displacement to a specimen, and a test sensor configured to measure a response from the specimen to the applied load and/or displacement or provide feedback for controlling the controllable element. The testing system controller is configured to operate on at least one computer to execute a test program to perform a test operation, which includes controlling the controllable element to apply a load and/or a displacement to a specimen in accordance with one or more controllable element activities of the test program, and writing sensor data corresponding to the test sensor to a designated computer-readable medium in accordance with one or more sensor data writing activities of the test program. The sensor data includes sensor calibration data corresponding to one or more calibration parameters of the test sensor, and/or sensor information data comprising non-sensed information about the test sensor.

In one embodiment, the controllable element is selected from the group consisting of a hydraulic actuator, a pneumatic actuator and an electric actuator, and the test sensor is selected from the group consisting of a load cell, a torque transducer, a pressure transducer, a displacement sensor, an extensometer and an accelerometer.

In one embodiment, the one or more sensor data writing activities each define the designated computer-readable medium and a format in which the sensor data is written during execution of the sensor data writing activity.

In one embodiment, the format is selected from the group consisting of extensible markup language, comma-separated values and tab-delimited values.

In one embodiment, the sensor data includes the sensor calibration data, which includes: an excitation value corresponding to a voltage of an excitation signal used to drive the test sensor to sense a condition; a scale for the test sensor defining minimum and maximum values for the output from the test sensor; a gain for the output signal generated by the test sensor; a demodulation phase of the output signal generated by the test sensor; a polarity of the output signal generated by the test sensor; a calibration method type used to calibrate the test sensor; a zero of the output signal generated by the test sensor; linearization data defining a transformation or conditioning used to translate sensed values output by the test sensor to expected values; a tuning parameter of the test sensor corresponding to adjustable properties of the control loop type; and/or a tuning parameter name corresponding to the tuning parameter of the test sensor.

In one embodiment, wherein the sensor data includes the sensor information data, which includes: a sensor conditioner serial number identifying the sensor conditioner; a dimension corresponding to a value represented by the output signal generated by the test sensor; a hardware resource identifier of a hardware resource of the sensor conditioner; a calibration date identifying when the test sensor was last calibrated; a manufacturer name identifying a manufacturer of the test sensor; a model identifying a model of the test sensor; a sensor name identifying the test sensor; and/or a serial number of the test sensor.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter. The claimed subject matter is not limited to implementations that solve any or all disadvantages noted in the Background.

### BRIEF DESCRIPTION OF THE DRAWINGS

FIG. 1 is a simplified diagram of an example of a dynamic testing system, in accordance with embodiments of the present disclosure.

FIG. 2 is a simplified diagram illustrating an example screenshot of a graphical user interface produced by a test program generator, in accordance with embodiments of the present disclosure.

FIG. 3 is a simplified diagram illustrating an example computing environment or computing device, in accordance with embodiments of the present disclosure.

### DETAILED DESCRIPTION OF ILLUSTRATIVE EMBODIMENTS

Embodiments of the present disclosure are described more fully hereinafter with reference to the accompanying drawings. Elements that are identified using the same or similar reference characters refer to the same or similar elements. The various embodiments of the present disclosure may, however, be embodied in many different forms and should not be construed as limited to the embodiments set forth herein. Rather, these embodiments are provided so that this disclosure will be thorough and complete, and will fully convey the scope of the present disclosure to those skilled in the art.

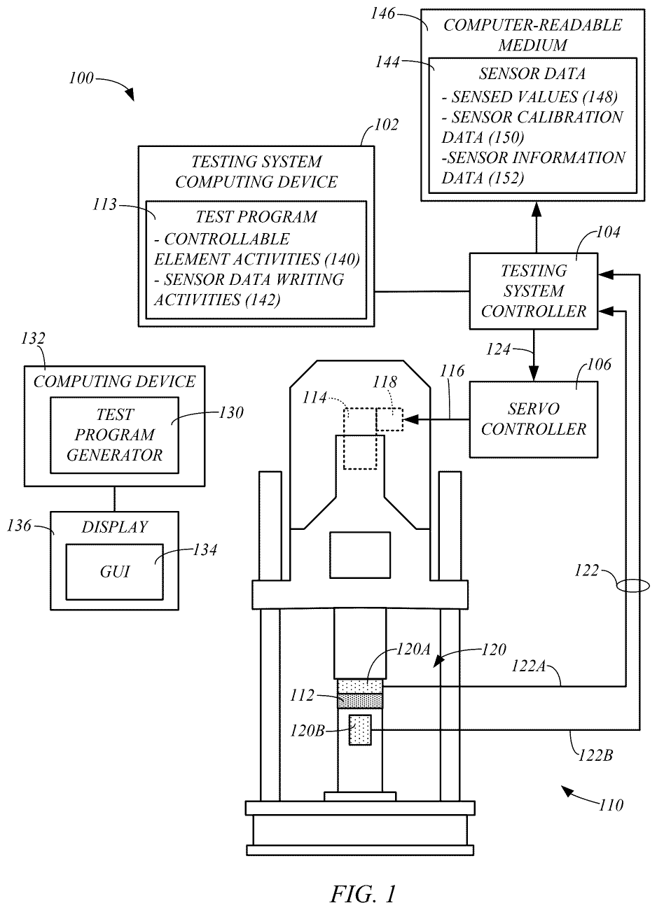

FIG. 1 illustrates an example of a dynamic testing system 100, which may include a testing system computing device 102, a testing system controller 104, a servo controller 106 and one or more test machines 110 for performing a test operation on a specimen 112 (e.g., material sample, substructure or components, etc.). A test program 113, which defines a test operation, may be executed by the testing system computing device 102, to generate instructions for controlling the testing system controller 104 to perform the test operation.

The illustrated example test machine 110 includes at least one controllable element or actuator 114 (e.g., hydraulic, pneumatic and/or electric) for imparting displacements and/or loads to a directly or indirectly coupled specimen 112 to excite the specimen 112. A controlled device 118 (e.g. servo valve, power controller) may be used to control the actuator 114 to provide a desired specimen excitation based on actuator command signals 116 generated by the servo controller 106.

One or more test sensors 120 provide feedback 122 to the testing system controller 104 in the form of a measured or an actual response to an actuation of the specimen 112 during the test operation. The one or more test sensors 120 may include one or more transducers on the test specimen 112 or the test machine 110, such as a force transducer 120A (e.g., load cell, torque transducer, pressure transducer, etc.), and/or one or more other test sensors 120B, such as a displacement sensor, an extensometer, an accelerometer, or another test sensor, for example. The test sensors 120 provide measured or actual responses 122, such as signals 122A and 122B, as feedback to the testing system controller 104.

During a test operation, the testing system controller 104 may provide a reference or control signal 124 to the servo controller 106, which issues a corresponding actuator command signal 116 to the controlled device 118, which in turn drives movement of the actuator 114. The one or more test sensors 120 provide the feedback 122 to the testing system controller 104, which adjusts the control signal 124 according to the test procedure defined by the test program 113. It is understood that the dynamic testing system 100 shown in FIG. 1 is a simplified system (single channel case), and that embodiments of the present disclosure apply to systems 100 comprising multiple channels, such as multiple test sensors 120 or feedback components, and multiple actuators 114, for example.

The test program 113 may be generated using a test program generator 130 operated on a computing device 132, such as the testing system computing device 102, for example. The program generator 130 may be configured to generate a graphical user interface (GUI) 134 on a display 136. As discussed below, a user may define a test workflow of a test procedure through the GUI 134, which is used by the test program generator 130 to create the test program 113. Accordingly, the test program generator 130 may employ a “workflow” type program for creating the test program 113, such as described in U.S. Publication No. 20100077260, which is incorporated herein by reference in its entirety. The created test program 113 may be saved to a non-transitory computer-readable medium of the testing system computing device 102 or another suitable storage medium.

As discussed above, the execution of the test program 113 by the testing system computing device 102 causes the testing system computing device 102 to deliver instructions to the testing system controller 104 to perform a test operation or test workflow through the control of the one or more actuators 114 and other components of the one or more test machines 110 of the system 100. The test program 113 generally defines one or more controllable element activities 140, each defining an application of a load and/or a displacement to a specimen 112 using one or more of the controllable elements or actuators 114, and/or one or more sensor data writing activities 142, each defining a write operation of sensor data 144 to a non-transitory computer-readable medium 146 by the testing system controller 104, as indicated in FIG. 1.

Each controllable element activity 140 may define conventional activities during which one or more loads are applied to the specimen 112 using the one or more actuators 114, such as a tension, a compression and/or a torsion in one or more degrees of freedom. Such loads may be applied to the specimen 112 separately or at the same time. The controllable element activity 140 may also or alternatively subject the specimen 112 to controlled displacements that are applied separately or at the same time by the one or more actuators 114 in one or more degrees of freedom. Various parameters of the controllable element activity 140 may define the magnitude, direction, rate of change, and conventional aspects of the actuation defined by the controllable element activity 140.

The sensor data writing activities 142 may define variables, the data that is to be written to the variables, the format in which the data is to be written (e.g., extensible markup language, comma-separate values, tab-delimited values, raw text, etc.), and a location or address of the computer-readable medium 146 to which the data is to be written. Conventional sensor data writing activities 142 relate to the writing of sensed values 148, such as values corresponding to output signals 122 from the test sensors 120 corresponding to a sensed condition, such as a sensed load from a load cell, a sensed torque from a torque transducer, a sensed pressure from a pressure transducer, a sensed displacement from a displacement sensor, a sensed force or displacement from an extensometer, a sensed acceleration from an accelerometer, or another sensed value.

In some embodiments of the present disclosure, the test program 113 includes sensor data writing activities 142 that are unrelated to the sensed values 148. In some embodiments, the sensor data writing activities 142 are configured to write sensor calibration data 150 that includes one or more calibration parameters of the test sensors 120, and/or sensor information data 152 that includes non-sensed information about the test sensors 120.

Conventional test sensor calibrations are generally performed on the test sensors 120 by service technicians to determine the sensor calibration data or parameters used to ensure that the test sensors 120 operate properly during a test operation and their response signals 122 are properly interpreted by the testing system controller 104. For example, a load cell of a test machine is typically calibrated using a calibration sensor in the form of a reference load cell that is placed in series with the load cell of the test machine. The calibration parameters of the load cell of the test machine are set to ensure that the output from the load cell of the test machine matches that of the reference load cell. A crosshead position or other displacement set by the test machine may be calibrated based on a calibration displacement sensor (e.g., linear or angular displacement sensor) that measures the set displacement. An extensometer of a test machine may be calibrated using an extensometer calibrator that opens the extensometer a known distance or applies a known strain to the extensometer. Other types of test sensors may be similarly calibrated using conventional techniques.

The calibration of the one or more test sensors 120 produces sensor calibration data 150 that includes various conventional calibration parameters depending on the type of test sensor 120. The sensor calibration data 150, as used herein, includes one or more of the following parameters for one or more of the test sensors 120:
an excitation value corresponding to a voltage of an excitation signal used to drive the test sensor to sense a condition;
a scale for the test sensor defining minimum and maximum values for the output from the sensor;
a gain for the output signal generated by the test sensor (e.g., multiplication factor applied to the sensor output signal);
a demodulation phase of the output signal generated by the test sensor, which may be used to adjust the phase of the feedback signal based on an excitation signal to the sensor;
a polarity of the output signal generated by the test sensor, which defines a direction of motion;
a calibration method type used to calibrate the test sensor, such as Gain/Delta-K, Gain/Linearization, etc.;
a zero of the output signal generated by the test sensor (e.g., defines the output signal from the sensor that represents a zero value);
linearization data (e.g., data table) defining a transformation or conditioning used to translate sensed values output by the test sensor to expected values;
a tuning parameter of the test sensor corresponding to adjustable properties of the control loop type (e.g., proportional-integral-derivative control parameters); and
a tuning parameter name corresponding to (e.g., identifying) the tuning parameter of the test sensor.

The sensor information data 152, as used herein, includes one or more of the following:
a sensor conditioner serial number identifying the sensor conditioner;
a dimension corresponding to a value represented by the output signal generated by the test sensor;
a hardware resource identifier of a hardware resource of the sensor conditioner;
a calibration date identifying when the test sensor was last calibrated;
a manufacturer name identifying a manufacturer of the test sensor;
a model identifying a model of the test sensor;
a sensor name identifying the test sensor; and
a serial number of the test sensor.

Accordingly, when the test program 113 is executed by the testing system computing device 102, instructions are sent to the testing system controller 104 to perform a test operation that includes controlling the controllable element or actuator 114 to apply a load and/or a displacement to a specimen 112 based on one or more controllable element activities 140 of the test program 113, and writing sensor data 144 to a designated computer-readable medium 146 based on one or more sensor data writing activities 142 of the test program 113. In one embodiment, the sensor data 144 includes one or more of the sensor calibration data 150 and/or one or more of the sensor information data 152 described above.

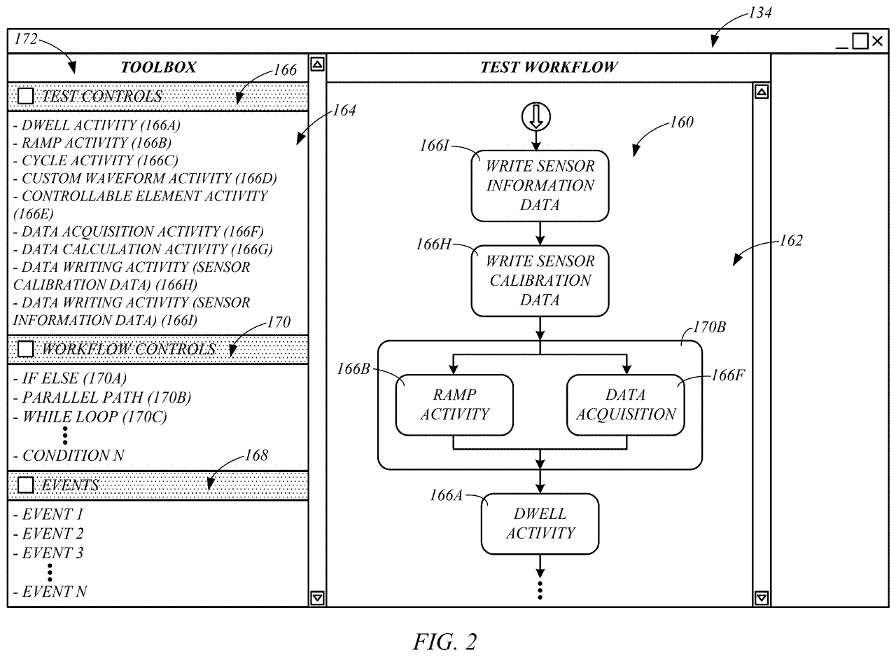

As discussed above, the test program generator 130 is configured to provide a GUI 134 on a display device 136 to facilitate programming a test workflow, in accordance with conventional techniques. FIG. 2 is a simplified diagram illustrating an example screenshot of a GUI 134 produced by the test program generator 130, in accordance with embodiments of the present disclosure. The illustrated GUI 134 includes an example test workflow 160 within a workflow window 162.

The test workflow 160 is generally a flowchart with a beginning, an end, and a sequential flow from start to finish of a test procedure that may be performed using one or more of the test machines 110. The building blocks of the test workflow 160 comprise workflow elements 164 that define test controls 166, events 168, workflow controls 170 and/or other workflow elements 164, that are performed by the testing system controller 104 during a test operation.

The workflow elements 164 may be contained within a toolbox window 172 of the GUI 134, as shown in FIG. 2. A graphical icon may be assigned to each workflow element 164. The test workflow 160 may be created by adding one or more of the workflow elements 164 to the workflow window 162 and interconnecting the workflow elements 164 based on user input (e.g., drag and drop operation) to form a flowchart (visual depiction) of the test procedure that forms the test workflow 160. Conventional parameters of the workflow elements 164 may be defined through user input to the GUI 134 when they are added to the test workflow 160. The test workflow 160 may include workflow elements 164 are sequentially performed, performed in parallel, performed based on conditions or looping, etc., in accordance with conventional test workflows.

The workflow controls 170 generally control a manner in which process steps are performed. For example, the workflow controls 170 may utilize conditional logic to establish one or more conditions that, if met, result in the performance of one or more events 166 or activities 168. Examples of some conventional workflow controls 170 include an if else 170A, a parallel path 170B, a while loop 170C, and other conventional workflow controls, such as a periodic time event, a repeat loop, etc.

When one of the workflow controls 170 is added to the test workflow 160 by adding it to the test workflow window 162, the user may define various conventional parameters of the added workflow control 170 through input to the GUI 134. For example, the if else workflow control 170A may include parameters that define the “if” condition that results in the performance of the “else” condition, such as a parameter relating to a value of a sensor signal 122 meeting a certain condition, such as the value exceeding a threshold value. Similarly, the while loop workflow control 170C has associated conventional parameters for defining the condition that maintains the performance of the loop and/or the condition that stops the performance of the loop. The periodic time event workflow control includes associated conventional parameters that specify the triggering of the event, and the repeat loop workflow control includes conventional parameters that may define the number of times a process is repeated, for example.

The test controls 166 include the controllable element activities 140 mentioned above that define an application of a load and/or a displacement to a specimen 112 using one or more of the controllable elements or actuators 114 of one or more test machines 110. Examples of conventional test controls 166 include a dwell activity 166A, a ramp activity 166B, a cycle activity 166C, a custom waveform activity 166D, and other conventional controllable element activities (e.g., sweep activity, etc.) 166E.

The dwell activity 166A directs the testing system controller 104 to issue a control signal 124 to hold a level for a specified duration of time, which are set by corresponding parameters (e.g., the hold level and the time period) that are defined through user input to the GUI 134.

The ramp activity 166B drives a control signal 124 from its current end-level state to a specified end level within a specified amount of time. The user-defined parameters of the ramp activity 166B include the specified end level and the specified amount of time.

The cycle activity 166C directs the testing system controller 104 to issue a control signal 124 that cycles between two different end levels at a specified frequency, using a specified wave shape, for a specified number of cycles. Two end levels form one cycle. The number of cycles determines the required number of end levels. The frequency determines the speed required to achieve the end levels. Accordingly, the user-defined parameters of the cycle activity 166C may include the frequency, the wave shape and the number of cycles.

The custom waveform activity 166D directs the testing system controller 104 to issue a control signal having a series of ramp and hold segments to make up a custom trapezoid waveform. Each ramp can have a different duration and end level, and each hold can have a different duration. The shape of the ramp segment is linear. The number of cycles determines how many times the entire custom waveform is generated. Thus, example user-defined parameters of the custom waveform activity 166D include the ramp duration and end level, the period of each hold, and the number of cycles.

The test controls 166 may also include data related activities, such as a data acquisition activity 166F, a data calculation activity 166G and a data write activities 166H and 166I. The data acquisition activity 166F configures the testing system controller 104 to obtain sensor data based on a sensor signal 122 output from a test sensor 120 and store the obtained data in a non-transitory computer-readable medium 146. The obtained data may be assigned to variables that may be used in the test workflow 160, in accordance with conventional test workflows. The data acquisition activity 166F may require at least one trigger and one signal. The trigger defines the method for acquiring data points (e.g. timed acquisition at a selected sample rate, when the value changes by a selected amount, etc.). The total number of data points to acquire can be prescribed. The data acquisition activity 166F is typically performed in parallel with one or more of the controllable element activities 140, such as the ramp 166B, as indicated in the example test workflow 160 of FIG. 2.

The data calculation activity 166G configures the testing system controller 104 to perform a calculation (e.g., strain calculation) based on the values obtained through one or more of the data acquisition activities 166F (e.g., specimen length, force, etc.) and store the calculated values in a non-transitory computer-readable medium 146. The calculated value may be assigned to a calculated variable used in the test workflow 160.

The data writing activities 166H and 166I include one or more of the data writing activities 142 mentioned. The data writing activity 166H configures the testing system controller 104 to perform a write operation 142 of one or more of the sensor calibration data 150 discussed above. The data writing activity 166I configures the testing system controller 104 to perform a write operation of one or more of the sensor information data 152 discussed above. The data writing activities 166H and 166I may specify a designated non-transitory computer-readable medium 146 to which the data 150 or 152 is to be written, a name for the data file containing the data 150 or 152, and/or a format in which the data 150 or 152 is written (e.g., extensible markup language, comma-separated values, tab-delimited values, text file, etc.).

The event workflow elements 168 are conventional workflow elements 164 that generally cause the testing system controller 104 to trigger a start or a stop to a portion of a test procedure. For example, the events 168 may function as a trigger based on when a calculated variable changes by more than a specified amount in a cycle, or when a comparison between two values is consistent within a defined percentage for a defined number of cycles (e.g., detection of a stable cycle). Likewise, an event 168 may be based on the detection of an upper or a lower limit in a signal, such as an output signal 122 from one of the test sensors 120. Events 168 may also include the detection of particular program states or state changes, for example.

Embodiments of the present disclosure also include a computer-implemented method for generating a test program 113 for a testing system 100 using the test program generator 130. In the method, the GUI 134 is provided to enable the receipt of user input to form a test workflow 160, such as in a test workflow window 162. The GUI 134 includes a display of a plurality of the workflow elements 164, such as in a toolbox window 172, as discussed above and shown in the example screenshot of FIG. 2, including one or more workflow elements 164 corresponding to the controllable element activities 140, such as the test controls 166A-E, and one or more workflow elements 164 corresponding to the sensor data writing activities 142 of the sensor calibration data 150 and the sensor information data 152, such as the test controls 166H and 166I.

A test workflow 160 is created in the test workflow window 162 based on conventional user input to the GUI 134, such as pointing and clicking, dragging and dropping, keyboard input, or other conventional user input. The user input to the GUI 134 places a plurality of the workflow elements 164 in the test workflow window 162 and connects the elements 164 together to form a test workflow 160 that defines a test procedure, as indicated in FIG. 2.

In one embodiment of the method, the user creates the test workflow 160 by adding one or more of the controllable element activities 140 through the addition of corresponding workflow elements, such as elements 166A-E, such as the dwell activity 166A and the ramp activity 166B, as shown in FIG. 2. In the example test workflow 160, the ramp activity 166B is included in a parallel path condition 170B.

The creation of the test workflow 160 also includes adding one or more of the data writing activities 142 to the test workflow window 162 through the addition of corresponding workflow elements 166H and/or 166I, as indicated in FIG. 2. As discussed above, the sensor data writing activities 142 define a write operation of sensor data 144, which corresponds to a test sensor 120 of a test machine 110 that is configured to measure a response from the specimen 112 to the applied load and/or displacement. In one embodiment, the sensor data 144 includes the sensor calibration data 150 corresponding to one or more calibration parameters and/or the sensor information data 152 comprising non-sensed information about the test sensor 120, as discussed above. The example test workflow 160 of FIG. 2 illustrates the addition of both data writing activities 166H and 166I to the test workflow window 162. Thus, the added workflow elements 166H and/or 166I do not include the writing of sensed values, which is covered by the data acquisition activity 166F, or the writing of calculated data, which is covered by the data calculation activity 166G.

One or more additional workflow elements 164 discussed above may also be added to complete the test workflow 160.

In the method, the test program 113 is generated based on the test workflow 160 and the test program 113 is saved in a non-transitory computer-readable medium, such as that of the testing system computing device 102, for example, in accordance with conventional techniques. The test program 113 may then be used (e.g., executed) by the testing system computing device 102 to provide instructions to the testing system controller 104 to perform a test operation through the control of one or more of the test machines 110, as discussed above.

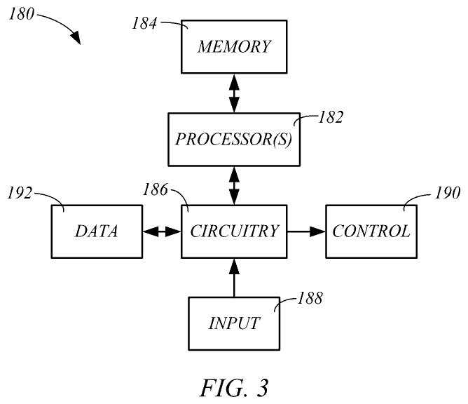

FIG. 3 is a simplified diagram illustrating an example computing environment or computing device 180 in which the testing system computing device 102, the testing system controller 104, the servo controller 106, and the test program generator 130 may be implemented, in accordance with embodiments of the present disclosure. The example computing environment or device 180 may include one or more processors 182 and memory 184, which may be local memory or memory that is accessible to the controller 182. The one or more processors 182 are configured to perform various functions described herein in response to the execution of instructions contained in the memory 184, for example.

The one or more processors 182 may be components of one or more computer-based systems, and may include one or more control circuits, microprocessor-based engine control systems, and/or one or more programmable hardware components, such as a field programmable gate array (FPGA). The memory 184 represents any suitable patent subject matter eligible computer-readable media and does not include transitory waves or signals. Examples of the memory 184 include conventional data storage devices, such as hard disks, CD-ROMs, optical storage devices, magnetic storage devices and/or other suitable data storage devices or computer-readable media.

The computing environment or device 180 may include circuitry 186 for use by the one or more processors 182 to receive input signals 188 (e.g., sensor signals 122, user input from a mouse, keyboard or touchscreen, etc.), issue control signals 190 (e.g., control signals 124, actuator control signals 116, control signals to the display 136, etc.) and/or communicate data 192 (e.g., sensed values 148, sensor calibration data 150, sensor information data 152, etc.), such as in response to the execution of the instructions stored in the memory 184 by the one or more processors 182.

Although the embodiments of the present disclosure have been described with reference to preferred embodiments, workers skilled in the art will recognize that changes may be made in form and detail without departing from the spirit and scope of the present disclosure.

What is claimed is:

1. A non-transitory computer-readable medium having stored thereon a test program that comprises instructions which, when executed by a processor of a testing system controller of a testing system, configures the testing system controller to perform a test operation comprising:
controlling a controllable element of a test machine to apply a load and/or a displacement to a specimen based on a controllable element activity of the test program; and
writing sensor data to a designated computer-readable medium based on one or more sensor data writing activities of the test program,
wherein:
the sensor data corresponds to a test sensor of the test machine that is configured to measure a response from the specimen to the applied load and/or displacement or provide feedback for controlling the controllable element; and
the sensor data is selected from the group consisting of:
sensor calibration data corresponding to one or more calibration parameters of the test sensor; and/or
sensor information data comprising non-sensed information about the test sensor.

2. The non-transitory computer-readable medium according to claim 1, wherein:
the controllable element is selected from the group consisting of a hydraulic actuator, a pneumatic actuator and an electric actuator; and
the test sensor is selected from the group consisting of a load cell, a torque transducer, a pressure transducer, a displacement sensor, an extensometer and an accelerometer.

3. The non-transitory computer-readable medium according to claim 1, wherein the one or more sensor data writing activities each define the designated computer-readable medium and a format in which the sensor data is written during execution of the sensor data writing activity.

4. The non-transitory computer-readable medium according to claim 3, wherein the format is selected from the group consisting of extensible markup language, comma-separated values and tab-delimited values.

5. The non-transitory computer-readable medium according to claim 1, wherein the sensor data includes the sensor calibration data, which is selected from the group consisting of:
an excitation value corresponding to a voltage of an excitation signal used to drive the test sensor to sense a condition;
a scale for the test sensor defining minimum and maximum values for the output from the test sensor;
a gain for the output signal generated by the test sensor;
a demodulation phase of the output signal generated by the test sensor;
a polarity of the output signal generated by the test sensor;
a calibration method type used to calibrate the test sensor;
a zero of the output signal generated by the test sensor;
linearization data defining a transformation or conditioning used to translate sensed values output by the test sensor to expected values;
a tuning parameter of the test sensor corresponding to adjustable properties of the control loop type; and
a tuning parameter name corresponding to the tuning parameter of the test sensor.

6. The non-transitory computer-readable medium according to claim 5, wherein the sensor data includes the sensor information data, which is selected from the group consisting of:
a sensor conditioner serial number identifying the sensor conditioner;
a dimension corresponding to a value represented by the output signal generated by the test sensor;
a hardware resource identifier of a hardware resource of the sensor conditioner;
a calibration date identifying when the test sensor was last calibrated;
a manufacturer name identifying a manufacturer of the test sensor;
a model identifying a model of the test sensor;
a sensor name identifying the test sensor; and
a serial number of the test sensor.

7. A computer-implemented method for generating a test program for a testing system comprising:
providing a graphical user interface (GUI) configured to receive user input;
displaying a plurality of workflow elements in the GUI including:
one or more controllable element activities, each defining an application of a load and/or a displacement to a specimen using a controllable element of a test machine during execution of the test program; and
one or more sensor data writing activities, each defining a write operation of sensor data during execution of the test program, wherein:
the sensor data corresponds to a test sensor of the test machine that is configured to measure a response from the specimen to the applied load and/or displacement or provide feedback for controlling the controllable element; and
the sensor data is selected from the group consisting of:
sensor calibration data corresponding to one or more calibration parameters of the test sensor; and
sensor information data comprising non-sensed information about the test sensor;
creating a test workflow comprising:
adding one or more of the controllable element activities to a test workflow window based on user input to the GUI; and
adding one or more of the data writing activities to the test workflow window based on user input to the GUI;
generating the test program based on the test workflow; and
saving the test program in a non-transitory computer readable medium.

8. The computer-implemented method according to claim 7, wherein:
the controllable element is selected from the group consisting of a hydraulic actuator, a pneumatic actuator and an electric actuator; and
the test sensor is selected from the group consisting of a load cell, a torque transducer, a pressure transducer, a displacement sensor, an extensometer and an accelerometer.

9. The computer-implemented method according to claim 7, wherein the one or more sensor data writing activities each define the designated computer-readable medium and a format in which the sensor data is written during execution of the sensor data writing activity.

10. The computer-implemented method according to claim 9, wherein the format is selected from the group consisting of extensible markup language, comma-separated values and tab-delimited values.

11. The computer-implemented method according to claim 7, wherein the sensor data includes the sensor calibration data, which is selected from the group consisting of:
an excitation value corresponding to a voltage of an excitation signal used to drive the test sensor to sense a condition;
a scale for the test sensor defining minimum and maximum values for the output from the test sensor;
a gain for the output signal generated by the test sensor;
a demodulation phase of the output signal generated by the test sensor;
a polarity of the output signal generated by the test sensor;
a calibration method type used to calibrate the test sensor;
a zero of the output signal generated by the test sensor;
linearization data defining a transformation or conditioning used to translate sensed values output by the test sensor to expected values;
a tuning parameter of the test sensor corresponding to adjustable properties of the control loop type; and
a tuning parameter name corresponding to the tuning parameter of the test sensor.

12. The computer-implemented method according to claim 11, wherein the sensor data includes the sensor information data, which is selected from the group consisting of:
a sensor conditioner serial number identifying the sensor conditioner;
a dimension corresponding to a value represented by the output signal generated by the test sensor;
a hardware resource identifier of a hardware resource of the sensor conditioner;
a calibration date identifying when the test sensor was last calibrated;
a manufacturer name identifying a manufacturer of the test sensor;
a model identifying a model of the test sensor;
a sensor name identifying the test sensor; and
a serial number of the test sensor.

13. A testing system comprising:
a test machine comprising:
a controllable element configured to apply a load and/or a displacement to a specimen; and
a test sensor configured to measure a response from the specimen to the applied load and/or displacement or provide feedback for controlling the controllable element; and
a testing system controller configured to operate on at least one computer to execute a test program to perform a test operation comprising:
controlling the controllable element to apply a load and/or a displacement to a specimen in accordance with one or more controllable element activities of the test program; and
writing sensor data corresponding to the test sensor to a designated computer-readable medium in accordance with one or more sensor data writing activities of the test program,
wherein the sensor data is selected from the group consisting of:
sensor calibration data corresponding to one or more calibration parameters of the test sensor; and
sensor information data comprising non-sensed information about the test sensor.

14. The testing system according to claim 13, wherein:
the controllable element is selected from the group consisting of a hydraulic actuator, a pneumatic actuator and an electric actuator; and
the test sensor is selected from the group consisting of a load cell, a torque transducer, a pressure transducer, a displacement sensor, an extensometer and an accelerometer.

15. The testing system according to claim 13, wherein the one or more sensor data writing activities each define the designated computer-readable medium and a format in which the sensor data is written during execution of the sensor data writing activity.

16. The testing system according to claim 15, wherein the format is selected from the group consisting of extensible markup language, comma-separated values and tab-delimited values.

17. The testing system according to claim 13, wherein the sensor data includes the sensor calibration data, which is selected from the group consisting of:
an excitation value corresponding to a voltage of an excitation signal used to drive the test sensor to sense a condition;
a scale for the test sensor defining minimum and maximum values for the output from the test sensor;
a gain for the output signal generated by the test sensor;
a demodulation phase of the output signal generated by the test sensor;
a polarity of the output signal generated by the test sensor;
a calibration method type used to calibrate the test sensor;
a zero of the output signal generated by the test sensor;
linearization data defining a transformation or conditioning used to translate sensed values output by the test sensor to expected values;
a tuning parameter of the test sensor corresponding to adjustable properties of the control loop type; and
a tuning parameter name corresponding to the tuning parameter of the test sensor.

18. The testing system according to claim 17, wherein the sensor data includes the sensor information data, which is selected from the group consisting of:
a sensor conditioner serial number identifying the sensor conditioner;
a dimension corresponding to a value represented by the output signal generated by the test sensor,
a hardware resource identifier of a hardware resource of the sensor conditioner,
a calibration date identifying when the test sensor was last calibrated;
a manufacturer name identifying a manufacturer of the test sensor,
a model identifying a model of the test sensor,
a sensor name identifying the test sensor, and
a serial number of the test sensor.
